(19) United States
(12) Patent Application Publication
(10) Pub. No.: US 2022/0005367 A1
(43) Pub. Date: Jan. 6, 2022

(54) SYSTEM AND METHODS FOR ADAPTIVE EDUCATION

(71) Applicant: The United States of America, as represented by the Secretary of the Navy, Arlington, VA (US)

(72) Inventors: Ralucca Gera, Seaside, CA (US); Michelle Lynn Isenhour, Pinehurst, NC (US); D'Marie Ellison Bartolf, Owings, MD (US)

(21) Appl. No.: 17/368,639

(22) Filed: Jul. 6, 2021

Related U.S. Application Data
(60) Provisional application No. 63/047,987, filed on Jul. 3, 2020.

(51) Int. Cl. G09B 5/06; G09B 5/12; G06F 16/435; G06F 16/438

(52) U.S. Cl. CPC G09B 5/067; G06F 16/438; G06F 16/435; G09B 5/12

(57) ABSTRACT

An adaptive education system is described. The adaptive education system includes a storage device to store aggregated learning content that includes learning units with learning material, the learning material having audio material, visual material, audiovisual material, or interactive material, CHUNKlets that each is of a CHUNKlet type and includes learning units, where the CHUNKlet type is an introductory type, an assessment type, an application type, or a methodology type, and CHUNKs that each includes CHUNKlets. The adaptive education system also includes an aggregation engine to group learning units into CHUNKlets and CHUNKlets into CHUNKs based on inputs from course authors and define prerequisite relationships between CHUNKs based on inputs from course authors.

### CROSS-REFERENCE TO RELATED APPLICATIONS

This patent application is a non-provisional of and claims the benefit of U.S. Provisional application No. 63/047,987, filed Jul. 3, 2020 which is hereby incorporated by reference in its entirety.

### BACKGROUND OF THE INVENTION

### 1. Field of the Invention

The present invention relates generally to self-directed adaptive education.

### 2. Description of the Related Art

Collegiate education is based on traditional lecturer-student interactions where the educator has a preset construct of how the course material should be conveyed to the students, usually in the form of a lecture, for a set amount of time, at frequent intervals, weekly or otherwise. Students are expected to learn the course material via the lectures as well as textbooks and other supplementary methods. Students can pose inquiries to the educator regarding the material to improve their understanding. As a basic educational structure this method works, but can inhibit both those who quickly grasp the subject matter and those who struggle, since they are all exposed to the same information at the same pace.

Much the same can be said regarding life-long learners, outside of a formal education program. Such students begin picking and choosing topics that interest them for professional, business, or personal interest.

Naturally, social connections form between students in similar curricula, professions, or businesses as they go through coursework together, as well as those that live together or participate in business or professional activities together. These connections grow into a social network of those participating in the common endeavor. From this social network, learning :styles can be observed and extended to groups of similar students to help them learn pricker and with greater impact. Adding this social network information to an adaptive learning system can allow better assignment and recommendation of content within the learning modules to each person, based on what the social network suggests about their interests, their preferred learning methods, and also the learning methods from their friends or colleagues. Using this educational aid, students can learn in a way that makes sense to them and lets them take more away from each education opportunity.

What is generally referred to as chunk learning entails recoding information into meaningful groups to be presented in a fashion to increase learning efficiency or capacity. The groups, called chunks, are formed based on meaningful or familiar relationships. Working memory capacity is increased by reducing the load presented to it. “In this way, the organism is able to decrease the amount of information that must be held in working memory by increasing the amount of information per chunk. Learning by chunking increases working memory capacity by reducing memory load and facilitates acquisition or recall by organizing long-term memory for information in perceived stimuli, motor sequences, or cognitive representations.” [Fountain S. B., Doyle K. E. (2012) Learning by Chunking. In: Seel N. M. reds) Encyclopedia of the Sciences of Learning. Springer, Boston, Mass.].

The subject technology is an improvement. The manner of forming and presenting CHUNKs can be improved to allow exploration, a networked rather than linear approach to learning, recommendation of learning pathways informed by social media information from other users, and dynamic adaptations based on the particular learner's progress.

### 3. Need for Subject Technology

What is needed is a system that allows each student to learn in ways that are effective for that particular student, whether it be watching videos, reading a book, reading through slides of the material, working example problems, running code, or a combination of those and other methods. Learning through these activities frees up the lecturing time, allowing the educator to teach at a higher level with deeper classroom discussion; whether that be critical thinking about the learned topics, teaching at an accelerated rate, focusing more on hands-on examples of the learned material, etc.

### SUMMARY OF THE INVENTION

Embodiments described herein provide self-directed adaptive education. The adaptive education system includes a storage device to store aggregated learning content that includes learning units with learning material, the learning material having audio material, visual material, audiovisual material, or interactive material, CHUNKlets where each CHUNKlet is a CHUNKIet type and includes learning units, where the CHUNKlet type is an introductory type, an assessment type, an application type, or a methodology type, and CHUNKs where each CHUNK includes CHUNKlets. The adaptive education system also includes an aggregation engine to group learning units into CHUNKlets and CHUNKlets into CHUNKs based on inputs from course authors and define prerequisite relationships between CHUNKS based on inputs from course authors.

Embodiments in accordance with the invention are best understood by reference to the following detailed description when read in conjunction with the accompanying drawings.

### BRIEF DESCRIPTION OF THE DRAWINGS

FIG. 1 shows an example architecture for a system providing adaptive education.

FIG. 2 shows an example network of knowledge for adaptive education.

FIG. 3 shows an example baseline template for types of CHUNKlets.

FIGS. 4A-4C show example workflows 400, 420, 440 for an adaptive learning system.

FIGS. 5A-5B show a CHUNK network 500 and an example exploratory path 522.

Embodiments in accordance with the invention are further described herein with reference to the drawings.

### DETAILED DESCRIPTION OF THE INVENTION

The following description is provided to enable any person skilled in the art to use the invention and sets forth the best mode contemplated by the inventor for carrying out the invention. Various modifications, however, will remain readily apparent to those skilled in the art since the principles of the present invention are defined herein specifically to provide adaptive education.

Embodiments herein describe a real-time and adaptive teaching-learning method for enhanced and personalized education. They provide a curated way of moving through a Network of Knowledge composed of reusable learning objects joined together by common attributes (i.e., tagged with competency or skill levels), rather than following the standard linear or tree-like system of lectures or chapters. CHUNK Learning thus enables the learner to Heuristically discover or learn based on personal background and interests, which should not only enhance the learner's talents but make them a more valuable resource.

In CHUNK learning, a learner's interests determine his/her own learning path through the Network of Knowledge with individualized learning outcomes. Each student benefits differently from the learning experience, based on his/her skills and desires. Simultaneously, the Network of Knowledge builds on the experiences of the students covertly guiding learners through the educational materials, much like online retail stores provides recommendations for buyers. This can be achieved by moving away from interdisciplinary teaching that transfers methods from one discipline to another, opting instead for a trans-disciplinary teaching approach that crosses the boundaries of many disciplines using a diverse choice of teaching tools and software.

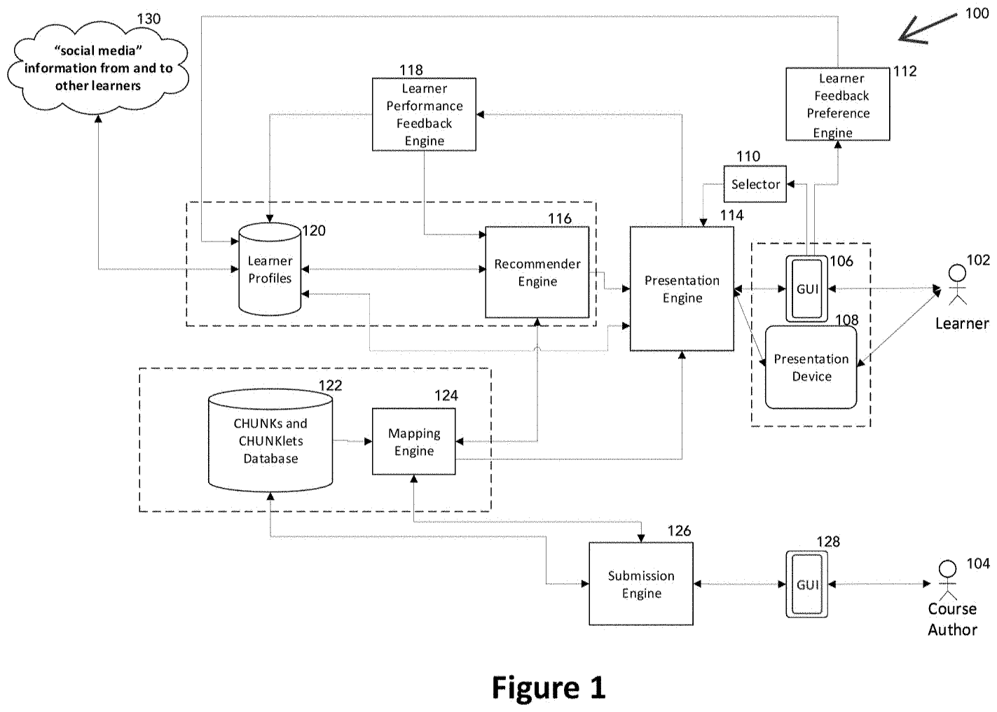

FIG. 1 shows an architecture for a system 100 providing adaptive education as further described in this application. The following definitions apply:

A “learner,” alternately called a “user” or “student” is an individual seeking knowledge through use of the system 100.

A “learner profile” comprises information from the learner regarding interests and preferred learning styles.

A “CHUNK” (Curated Heuristic Using a Network of Knowledge) comprises a topic to be learned, roughly equivalent to a section in a textbook. CHUNK content is broken down into smaller education materials, called “CHUNKlets.”

The “CHUNKlets” capture the breaking down of a topic into short and intense educational materials, allowing the learners to be engaged for a short period of time (and practice) before continuing to the next CHUNKlet. The CHUNKlets are categorized into four types: “Why”, “What”, “Methodology”, and “Assessment”. For each CHUNK, the CHUNKlets within the same category are interchangeable as they present the same topic from different points of view and different methods of delivery (e.g., video, audio, presentation slides, textual documents, etc.), allowing for personalized education when the most appropriate CHUNKS and/or CHUNKIets are suggested to the learner.

A many-to-many relationship exists between and among CHUNKs and CHUNKlets.

The subject technology uses a two-step process for recommending CHUNKs and CHUNKlets to each user to support personalized education, based on its current structure. First, relevant CHUNKs and CHUNKlets are determined based on the user's academic requirements and goals. Second, for each relevant CHUNK, the relevant CHUNKlets are ranked based on the user's learner profile and the social connections they share with other users in the system. The goal of this process is to maximize the chances that the learner will engage with CHUNKlets that are both useful and interesting to the learner. In one embodiment, the recommendation of a CHUNKlet is based on the learner profile's keywords. As such, personalizing the chosen CHUNKlet for each user is complemented by creating and utilizing a social network that ranks relevant CHUNKIets for each user. The newly proposed rating for each CHUNKlet is generated using the learner's profile and how that information links him/her to similar users, building on the CHUNKlet feedback provided from previous learners in the network. This maximizes the chances learners use methods that work for them. The built-in rating system is used to (1) collect data from users that have completed a CHUNK or CHUNKlet and (2) affect the ranking the CHUNK or CHUNKlet receives for other related users in the network, with the strength of that effect being determined by the strength of the individual's social connection with other users.

The system 100 requires identifying relevant connections between the users to accurately recommend appropriate new CHUNKlets to users; that is to say it relies on the overlaying social network that emerges between the users of the CHUNK Learning system. The subject technology discloses methods to generate a social network to inform system 100 by having the social network assign and modify a score of each CHUNKlet, to be used for recommendations to other users. The social network's nodes are the individual learner profiles and the edges (weighted and undirected) connect nodes with similar attributes. Attributes from each student profile are extracted and saved. Examples of such attributes are the current degree, branch of military service, previous degrees, and extracurricular interests.

Referring now to FIG. 1, system 100 is populated with learning, materials via course authors 104. Working through a graphical user interface GUI 128, working through a cell telephone, tablet, laptop or desktop computer, or the like, author 104 communicates to a submission engine 126 (i.e., aggregation engine). Content is submitted as Activities and aggregated into CHUNKlets, with some initial information with respect to Why, What, Methodology, and Assessment, and deposited into database 122. The CHUNKlets can then aggregated into CHUNKs, which also deposited into the database 122, where the CHUNKs and/or CHUNKlets await delivery to the learner.

Learner 102, upon seeking education through system 100, approaches a learner graphical user interface GUI 106 to make the request and to provide initial information for learner profile 120. The request is presented to selector 110, which in turn communicates with presentation engine 114. Presentation engine 114 communicates the request through learner preference feedback engine 112, and in turn to learner profile 120, seeking information associated with the particular learner 102 making the request. Cooperation and communication among learner profile 120 and a recommender engine 116 determine an initial set of CHUNKs and CHUNKlets to present to the learner 102. That determination is further communicated to a mapping engine 124 which makes the selected CHUNKs and CHUNKlets available to the presentation engine 114 for presentation. Actual presentation is accomplished to a desired presentation device 108, based on learner preference. The presentation device 108 may be that same device used with GUI 106, a separate similar electronic device, a video or audio device, or other device matching the methodology for the particular CHUNKlet.

From time to time during an education session, learner 102 may seek assessment, which is managed by performance feedback engine 118. If a learner 102 successfully completes an assessment, the successfully assessment is associated with the completed. CHUNK to verify that competency is achieved. Assessment information is retained and is available to the recommender engine 116, to be used in subsequent recommendations of CHUNKS and CHUNKlets.

The system 100 also addresses a cold start problem; establishing an initially useful state on first use by the learner 102. That is, how best to match a new user to material that fits his or her interests and learning style; particularly when little to no knowledge of the user's actual preferences is assumed. In system 100, and particularly managed via recommender engine 116, an assumption is that the learner profile information provided by the average user is incomplete, and it will be updated as the learner progresses through the CHUNKs, making it easier to b at that point. In particular, an assumption is that the directed learners will provide the least amount of information, combined with a further assumption that their motivation to provide information is the lowest.

Also consider a network cold-start problem; With little user data on-hand, how best to acquire useful information over time to identify emergent connections and apply collaborative filter methods? Putting in another way, how does the network improve its recommendations and internal connections through implicit or explicit feedback? System 100, in one embodiment, present a hybrid networked approach to overcome the cold-start problems.

Learners and content are treated as nodes on a network, and system 100 combines elements of content-mapping with syntactic sorting to determine a learner's initial location on this network. System 100 incorporates feedback and learning objective completion to update the user's location in the network of knowledge and then provide the user with recommendations to help guide the leaner through the network.

The social network can be created using learner profiles 120 as the nodes, and the attributes of those nodes as criteria to create edges. If two nodes have the same attribute, they can be connected by an edge in the social network. Attribute selection is limited to a predefined set of options to ensure uniform responses for a given category. This minimizes errors during data entry and ensures rank and designator selections correspond to the selected service. As the network grows, new categories and/or attributes may be added.

For this description, a set list of categories and attributes is created to generate a. usable network, as a subset of the CHUNK Learning system's 100 list of attributes. The selected categories have either a drop-down list of attributes for single selection or a multiple-choice list for attributes which may contain multiple items, such as extracurricular interests and classes. in one example, the categories can be the following:

1) Rank

2;) Service

3) Designator/MOS

4) Masters (Current Curriculum)

5) Major (Previous Degrees)

6) Extracurricular Interests

7) Classes.

The model focuses on the recommendation of CHUNKlets by the recommender engine 116 and assumes CHUNKs have already been selected for the learner 102 directed for the course he/she is enrolled in, since the CHUNKlets are interchangeable within their category. For this example, the model can be limited to 11 courses, with each course containing exactly one CHUNK and each CHUNK containing exactly three CHUNKlets.

In some cases, a social network can be generated, in part, based on users 102 and their initial ratings for each CHUNKlet. As new users 102 are introduced to the social network, they are connected to existing users 102 based on the attributes they select. Stronger or weaker connections between the users 102 can be determined based on similarity of their attributes.

The social network is created by determining how strongly each user 102 is connected to every other user 102. First, each category is weighed for importance to determine social connectivity. As an example, current degree may be given a weight of three and past degree may be given a weight of one, indicating connections made using a user's 102 current degree are three times more important than connections made using a user's 102 past degrees.

Next, for each category, the category's weight is used to form weighted edges between users if the users share an attribute in that category. Finally, these edges are added together to form the connections in the overall social network, where the weighted edge between each pair of users 102 determines how well-connected they are. Those skilled in the art will appreciate that the social network described is optional. The social network can be implemented to address the cold-start problem.

The effect of the social network on CHUNKlet recommendations is now explored. As new users 102 are introduced to the network and connected to existing users 102, the score of a CHUNKlet is updated for that user 102 and may result in different recommendations. These suggestions for CHUNKIets are based on the highest scored CHUNKlet in that category.

Though the method for constructing the edge weights in the social network remains the same, three methods for the edge weights can be used to determine CHUNKlet ratings. Let x be a new user 102, and y, z be existing users 102 in the network.

1) The linear method: the CHUNKlet's rating is proportional to the social edge weights. If the weight of the edge x, y is 5, and the weight of the edge is 10, then user z 102 have twice the impact that user y 102 has on the suggestions presented to x.

2) The exponential method: the impact a user 102 has on CHUNKlet ratings grow exponentially with their social weight.

3) The tier method: in this method, connections between users 102 are split into three tiers according to the social weight connecting them. Highly connected individuals fall into Tier 1, followed by Tier 2, and then Tier 3, as their social weight decreases. All individuals in the same tier have the same impact on CHUNKlet ratings—i.e. 6 for the top tier, 3 for the middle, and 1 for the bottom tier.

Each method has potential benefits and drawbacks. The tiered approach prevents highly connected users 102 from drowning out less connected users 102 but could also result in dissimilar users 102 having the same effect as those slightly similar, depending on the bounds of each tier. The exponential method does the opposite, it magnifies the effect highly similar users 102 have on each other. The linear method is the middle ground between tiered and exponential. As more users 102 interact with the CHUNKlets the recommendations of the recommender engine 116 become more robust.

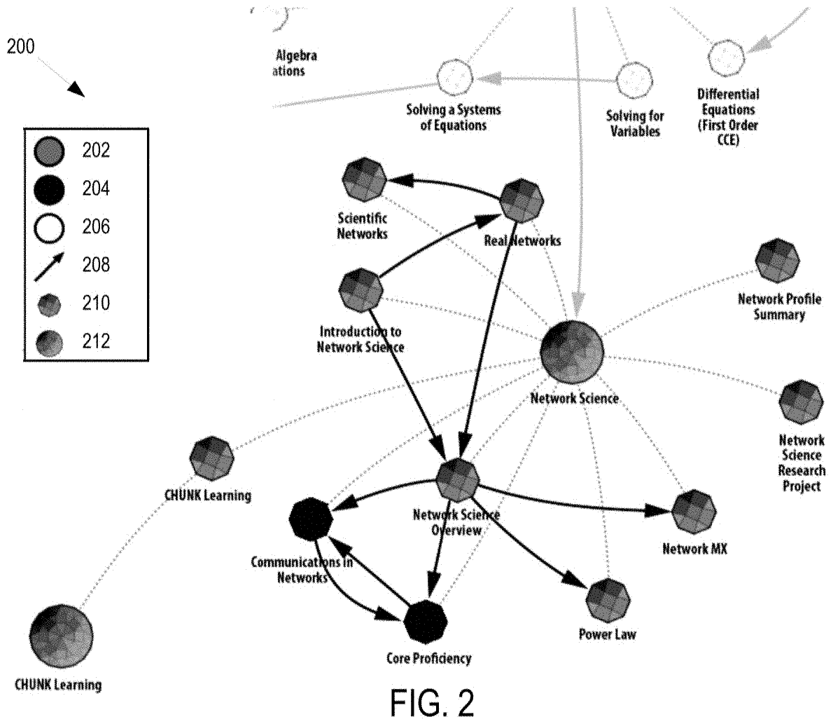

FIG. 2 shows an example network of knowledge 200 for adaptive education. The network of knowledge 200 depicts relationships between CHUNKs 210. In this example, CHUNKs 210 are further aggregated into courses 212 (e.g., the Network Science course 212 includes several relevant CHUNKs 210). The directional arrows 208 between CHUNKs 210 depict prerequisite relationships. In this example, enrolled CHUNKs 210 are black 204, completed CHUNKs 210 are grey 202, and unenrolled CHUNKs 210 are white 206.

A learner can use the network of knowledge 200 to quickly review their learning progress in CHUNKs 210 of various learning topics. In this example, the learner can identify potential CHUNKs 210 to complete next.

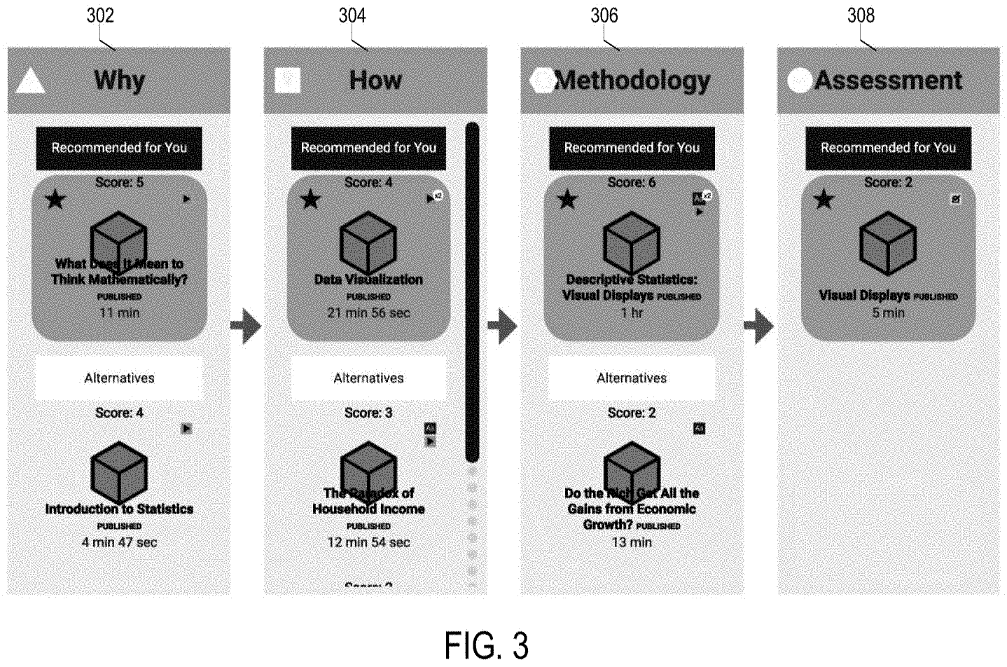

FIG. 3 shows a baseline template 302-308 for types of CHUNKlets. This shown format of the templates 302-308 facilitates learning as an adaptation of Simon's “Why-What-How” format. For example, in introductory courses in science, the common practice is to provide a motivation for the concept-to-be-introduced, with the message that the learner will eventually be using the learned concepts. CHUNK Learning's “Why-How-Methodology-Assessment” reverses this process. It is top-down teaching by anchoring the concept-to-be-introduced to each learner's knowledge before introducing the methodology for the new concept. It shows each learner how the content is used in that learner's specific field of study, so that it has meaning and context to the learner before the learner even engages with the new content. This is accomplished by having multiple choices for each of the category in “Why” 302, “How” 304, “Methodology” 306, and “Assessment” 308, to optimize the matching of the content to each user. Throughout this description, “user,” “student,” and “learner” are used interchangeably.

“Why”; Tantalizing the Learner 302: for example, learners open a “Why” CHUNKlet 302 to reveal an enticing one-of-its-kind educational trailer. The goal of CHUNK Learning is to make the student eager to learn, so CHL Ks can begin with a demonstration on why learning a particular topic is important. Much like a movie trailer attracts movie-goers to a movie, the “Why” CHUNKlet 302 attracts an exploratory learner to the CHUNK Learning module, answering the following questions:

Why is the topic relevant?

Why should students learn the topic?

“How”: Applications, Real and Relevant 304: learners dive into the “How” CHUNKIet 304 to uncover real and relevant applications. Here, learners discover the answer to the often-asked question, “When will I ever use this in real life?” Answers the following questions are also sought:

How is the topic applied in practice?

How does the learner validate what he/she already knows?

How are the learning outcomes tested?

How is new information, anchored to the learner's interests, incorporated into the module?

How can the learner apply the acquired skill/knowledge?

Methodology: A Variety of Delivery Methods 306: instructors carefully curate the Methodology CHUNKlets 306, guiding students though a variety of personalized course materials and delivery methods, including MOOCs and Creative Commons Licensed resources, as well as instructor-created content. For interactive modules, it is envisioned that instructors can follow the “I do it, We do it, You do it” model. The “Methodology” CHUNKlets' 306 main focus should be on answering the following questions:

What new information and skills will the module deliver?

What activities will the learner be required to perform?

What learning outcomes will the learner acquire?

What different methodologies could be used to engage with this new knowledge?

Assessment: Competency Based 308: learners can jump into the “Assessment” CHUNKlet 308 at any point to test their knowledge on any given topic. Assessments are available for every CHUNK. Opportunities for remedial learning may be present. Successful completion results in a CHUNK competency credit.

What is the competency-based framework, designed around learning objectives, needed for each CHUNK?

How should remediation be tested?

How should the post-test differ from the pre-test?

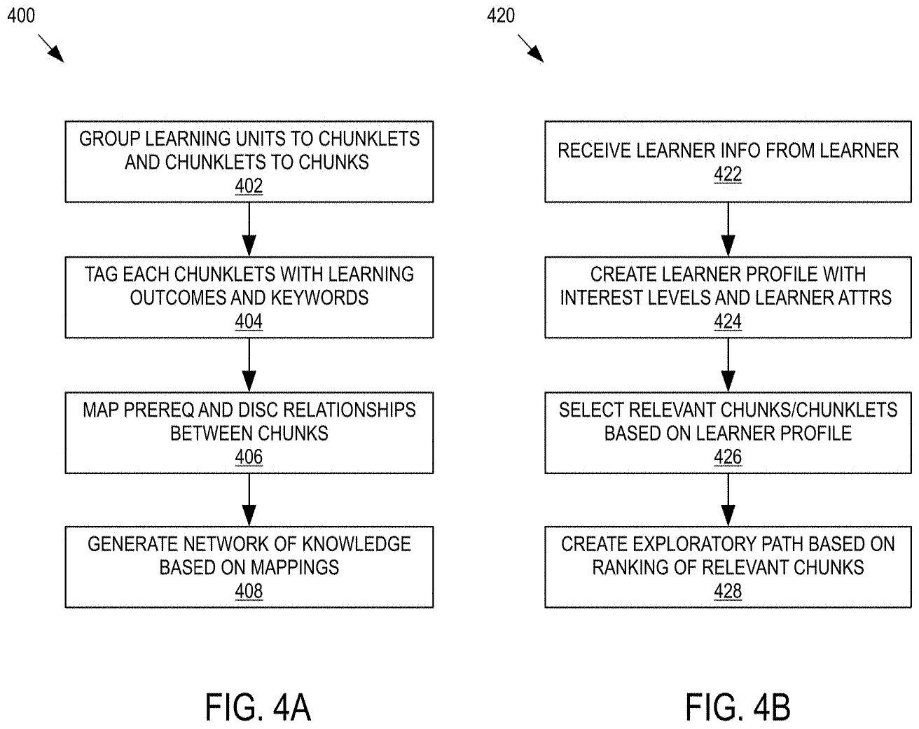

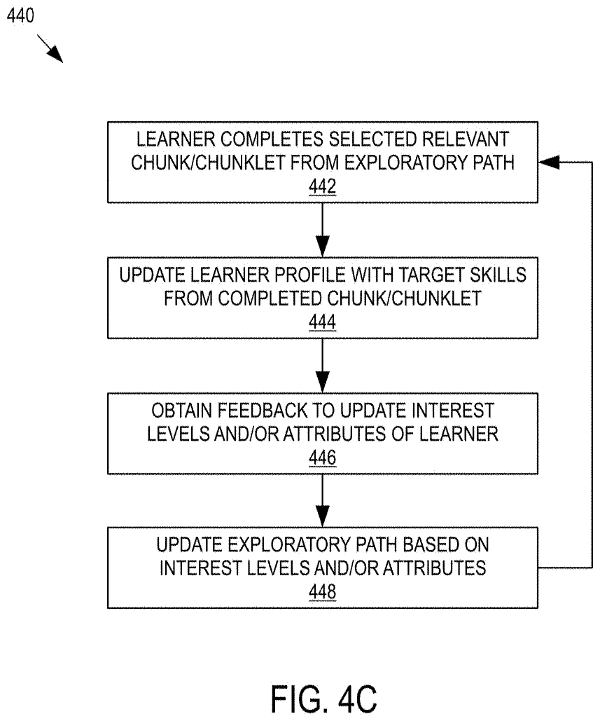

FIGS. 4A-4C illustrate example workflows 400, 420, 440 for an adaptive learning system. As is the case with the other processes described herein, various embodiments may not include all the steps described below, may include additional steps, and may sequence the steps differently. Accordingly, the specific arrangement of steps shown in FIGS. 4A-4C should not be construed as limiting the scope of embodiments described herein.

FIG. 4A shows an example workflow 400 for generating a network of knowledge. In block 402, learning units are grouped into CHUNKlets, and CHUNKlets are grouped into CHUNKs. In one example, the groupings are specified by a course author via a user interface. In another example, the groupings can be determined by artificial intelligence based on previous learning activities of all learners of the adaptive education system.

In block 404, each CHUNKlet can be tagged with learning outcomes (e.g., acquisition of target skills) and descriptive keywords. The tagging can be performed as described above with respect to block 402 t. e.g., course author, artificial intelligence, etc.).

In block 406, prerequisite relationships and disciplinary relationships are mapped between CHUNKs. In one example, the course author can specify the prerequisite and/or disciplinary relationships between CHUNKlets and/or CHUNKs. Disciplinary relationships may be intra-disciplinary or inter-disciplinary such that the same learning content can be used across multiple disciplines.

In block 4B, a network of knowledge can be generated based on the groupings, tags, and relationships. For example, the network of knowledge may be as described above with respect to FIG. 2.

FIG. 4B shows an example workflow 420 for generating an exploratory learning path. In block 422, learner information is received from the learner. For example, the learner can complete a wizard designed to collect information from the learner. In another example, the learner information can be collected by intermittent surveys (e.g., after the learner completes a CHUNK or CHUNKlet.

In block 424, a learner profile is created using the collected learner information. The learner profile can include learner preferences, learner attributes (e.g., degrees, certifications, skills, etc.), completed courses, etc. In block 426, relevant CHUNKs and/or CHUNKlets are selected based on the learner profile. In block 428, the relevant CHUNKs and/or CHUNKlets are used to build an exploratory path for the learner. In one example, the exploratory path may be similar to a portion of the network of knowledge described above with respect to FIG. 2. In another example, the exploratory path can be a recommendation of several classes with descriptions. The learner can use the exploratory path to determine the next best course to complete in their learning journey.

FIG. 4C shows an example workflow 440 for updating an exploratory path based on user feedback. In block 442, the learner selects and completes a relevant CHUNK or CHUNKIet from their exploratory path. After the course is completed (optionally including a requirement that the learner obtain an acceptable score on an assessment CHUNKlet, a learner profile of the learner is updated with target skills from the completed CHUNK or CHUNKlet in block 444. For example, completion of a financing CHUNK could award proficiency in an accounting skill.

In block 446, feedback is obtained from the learner to update their interest level in topic and/or attributes of the learner. Similar as described above for FIG. 4B, the feedback can be obtained by a variety of methods including, but not limited to, pop-up surveys, information collection wizards, email surveys, etc. In block 448, the exploratory path of the learner is updated based on the update learner profile. For example, completion of a prerequisite course can unlock any dependent courses in the exploratory path. At this stage, the workflow 440 can return to block 442 for the learner to select and complete their next CHUNK/CHUNKlet so the process can be repeated.

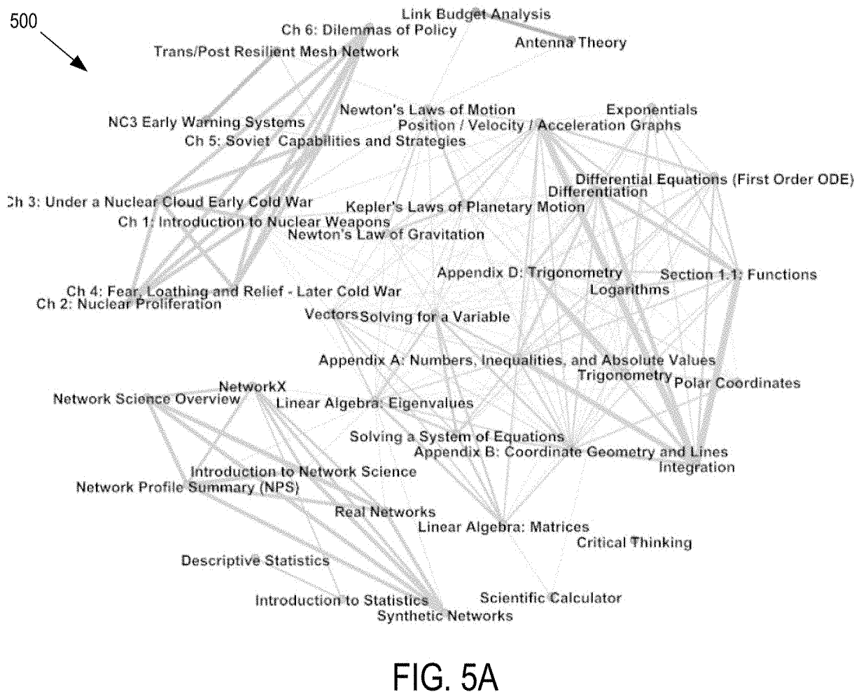

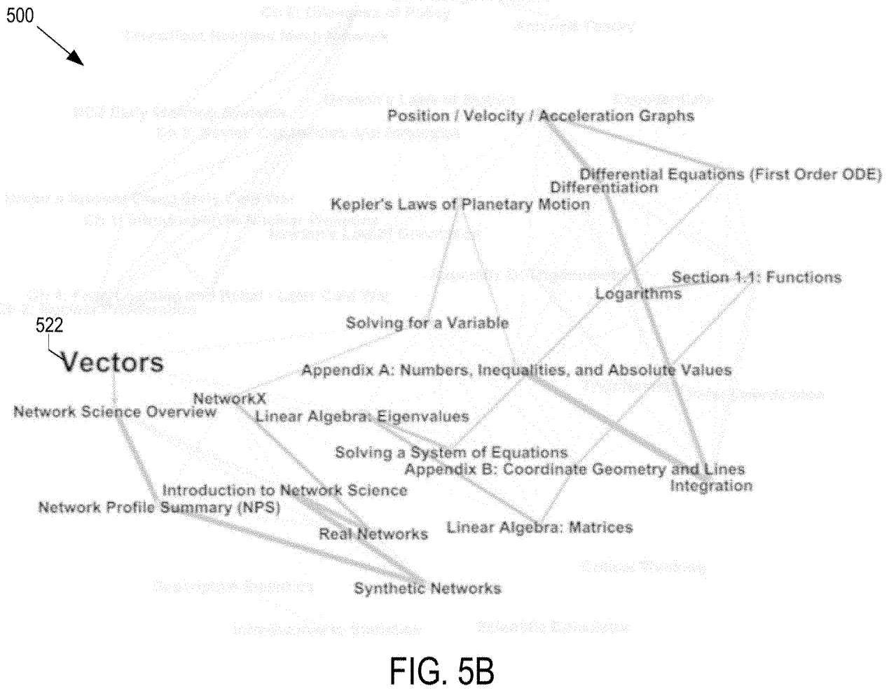

FIGS. 5A-5B show a CHUNK network 500 and an example exploratory path 522. In this example, the CHUNK network 500 is stripped of any ontological structure. Therefore, the data is saved, CHUNKs are not directly connected to each other by topic or any prerequisite relationship. This allows the user to be unfettered in his or her path through the network 500. In contrast to the network in FIG. 2, a strongly connected network 500 of CHUNKs is created, where each CHUNK can be reached from every other CHUNK. For visualization and comparison purposes, a similarity value is computed between each pair of CHUNKs and display the CHUNK network 500. Note the logical grouping of CHUNKs into communities based on CHUNK title. While the ontological structure of the network is absent, a natural structure occurs based on similarity values. The methodology for computing this similarity value is described below.

To make relevant recommendations in this example, the recommendation system relies on computing similarity values between pairwise CHUNKlets, the user and each CHUNK, and subsequently between the user and each CHUNKIet. To compute the similarity value, the cosine distance between two vectors in a 1×k-dimensional space or a 1×l-dimensional space, where k and l are the cardinalities of the network's 500 CHUNK or CHUNKlet keyword sets, respectively. The CHUNKs and/or CHUNKlets (across all CHUNKlet types) with the highest similarity value relative to the user are recommended first. Before providing a methodology for computing this similarity value, system information and structure requirements are outlined:

1) Initial System Inputs. The system resides in an information database, where each entity (CHUNK, CHUNKlet, and user) is identified with a profile(s). This profile has a unique identifier, a set of keywords, and, in the case of a CHUNK-CHUNKlet, a parent-child relationship. System administrators decide on CHUNK titles, and instructors upload CHUNKlets. When CHUNKlet upload occurs, the instructor must do four things: define the parent-child relationship between the CHUNKlet being uploaded and the CHUNK that it is assigned, categorize the CHUNKIet with one of the four categories “Why”, “What”, “Methodology”, or “Assessment”, assign to the CHUNKlet content keywords, and assign to the CHUNKlet learning method keywords (Video, PowerPoint, etc.).

2) User Profile Vectors. Two profile vectors will be built for each user: one based on content keywords that will be used for computing similarity values between the user and each CHUNK, and one based on learning method keywords that will be used for computing similarity values between the user and CHUNKlet. The first will be a 1×k-dimensional vector, where k is the cardinality of the network's content keyword set, and the second will be a 1×l-dimensional vector, l being the cardinality of the set comprising learning methods keywords. The system populates the user's vectors when the user initially creates his or her profile. It is a binary vector, where a one represents the user's interest in that keyword, and a zero represents no feedback or negative feedback in that keyword. The way the system obtains these keywords from the user during initial profile build is left to the current system administrators.

3) CHUNKlet Profile Vectors. CHUNKlets have two profile vectors: a 1×k-dimensional content keyword vector and a 1×k-dimensional learning method keyword vector. They are populated when the instructor uploads the CHUNKlet into the CHUNK Learning system based on that instructor's input.

4) CHUNK Profile Vector. Like the user's content keyword vector, the CHUNK's keyword vector is 1×k-dimensional, but it is not a binary vector, rather it is the sum of the vectors of its CHUNKlets. That is, the value associated with each keyword position in the vector will be based on the parent-child relationship between each CHUNK and CHUNKlet. The keywords associated with the CHUNKlet that the instructor tagged during upload will aggregate within the CHUNK, and this aggregated number will be the value for the keyword's position within the vector. Therefore, unlike the user's initial content keyword vector of ones or zeros, the CHUNK's keyword vector is not limited to a binary value.

Now that the system has its requisite information and appropriate vector lengths, the cosine distance between vectors can be computed so that the CHUNKlets with the highest cosine distance value can be provided as recommendations. This is performed in a two-round process.

Recommendation Round. Using the standard linear algebra cosine distance formula, the distance is computed between the user's keyword vector and all CHUNK keyword vectors. CHUNKs are then ranked from highest to lowest similarity value, and the first ranked CHUNK is recommended first. The user can accept or reject the CHUNK that is recommended, but this example focuses on users that accept the first recommendation. Once the user accesses the CHUNK, another cosine distance is calculated between the user's learning method vector and all CHUNKlets associated with the current CHUNK. The closest in CHUNKlets for each CHUNKlet type are recommended in decreasing order, where in represents the desired number of CHUNKlets shown based on system administrators' input.

User. Feedback Round. During this round, the user completes CHUNKlets within the current CHUNK. Implicit feedback, such as the length of videos watched, may be captured during this phase. Further, explicit feedback, which can be captured at the completion of each CHUNKlet and CHUNK, may also be captured.

In the CHUNKlet case, the user can be presented with a choice of rating the CHUNKlet as either a “like” or a “dislike”. The user's learning method profile vector will then be adjusted by multiplying a scalar value to the vector entry associated with the CHUNKlet type, expanded upon later below.

In the CHUNK case, the user will be presented with the same “dislike” or “like” question regarding the CHUNK as a whole, but if the user indicates positive feedback, a second feedback question will be asked. To support an adaptive CHUNK Learning system, this feedback round presents the user with the top three keywords (based on frequency) associated with the CHUNK and asks the user for either positive or negative feedback for each of the three keywords. The feedback collected will then impact the keywords attached to the CHUNK.

Lastly, to make the profiles adaptive, the user's profile vector will then be adjusted by multiplying a scalar value to the keyword(s) position in his or her content keyword vector. Additionally, if the user indicates positive feedback on any of the three keywords shown at the end of the CHUNK, and that keyword is not already represented in the user's keyword vector, a “1” value will be added to the user's keyword vector before the scalar is applied. This enables the user to prolong his or her exploration in the CHUNK Learning network by making it possible for related CHUNKs to be suggested to the user.

In one example, the “like” scalar value can be set to 1.05 and the “dislike” scalar value can be set to 0.01. These values can be adjusted depending on system administrator preference. Because of these updates, the CHUNK Learning system can be considered to have “dynamic profiles”, since each user's profile adjusts according to explicit feedback.

Upon completion of a CHUNK, that CHUNK's similarity value to the user profile will be assigned the value zero. This is to prevent the user from being recommended a CHUNK that has already been completed.

The process then repeats. It should be noted that this methodology is applicable to both directed and exploratory learners. For the directed learner case, users may take a different path through the network than a purely exploratory learner might, but they can still use and benefit from the feedback mechanisms built into the system particularly in respect to the learning methods presented over time.

The invention may be implemented on virtually any type of computer regardless of the platform being used. For example, a computer system can include a processor, associated memory, a storage device, and numerous other elements and functionalities typical of today's computers. The computer may also include input means, such as a keyboard and a mouse, and output means, such as a display or monitor. The computer system may be connected to a local area network (LAN) or a wide area network (e.g., the Internet) via a network interface connection. Those skilled in the art will appreciate that these input and output means may take other forms.

Further, those skilled in the art will appreciate that one or more elements of the computer system may be located at a remote location and connected to the other elements over a network. Further, the invention may be implemented on a distributed system having several nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

This description provides exemplary embodiments of the present invention. The scope of the present invention is not limited by these exemplary embodiments. Numerous variations, whether explicitly provided for by the specification or implied by the specification or not, may be implemented by one of skill in the art in view of this disclosure.

It is to be understood that the above-described arrangements are only illustrative of the application of the principles of the present invention, and it is not intended to be exhaustive or limit the invention to the precise form disclosed. Numerous modifications and alternative arrangements may be devised by those skilled in the art in light of the above teachings without departing from the spirit and scope of the present invention.

What is claimed is:

1. An adaptive education system, comprising
a storage device to store aggregated learning content that comprises:
learning units comprising learning material, the learning material comprising at least one from a group consisting of audio material, visual material, audiovisual material, and interactive material,
CHUNKlets, each CHUNKlet being of a CHUNKlet type and comprising a plurality of learning units, wherein the CHUNKlet type is one from a group consisting of an introductory type, an assessment type, an application type, and a methodology type, and
CHUNKs, each CHUNK comprising a plurality of CHUNKlets; and an aggregation engine to:
group learning units into CHUNKlets and CHUNKlets into CHUNKs based on inputs from course authors; and
define prerequisite relationships between CHUNKs based on the inputs from the course authors.

2. The adaptive education system of claim 1, further comprising a submission interface to receive the input from the course authors.

3. The adaptive education system of claim 1, further comprising a mapping engine to:
tag each of the CHUNKlets with learning outcomes and descriptive keywords;
map, in a network of knowledge, the prerequisite relationships through directed edges that connect each CHUNK with required CHUNKs of the CHUNK; and
map, in the network of knowledge, disciplinary relationships through bidirectional edges between CHUNKs, each disciplinary relationship capturing an aggregation of CHUNKs that represent a unit or a topic of knowledge.

4. The adaptive education system of claim 3, further comprising a presentation engine to display a portion of the network of knowledge that represents the directional edges between CHUNKs and the bidirectional edges between the CHUNKs and the units and the topics of knowledge.

5. The adaptive education system of claim 3, further comprising a social network engine to:
create a social learning network with two layers, wherein the first layer tracks learning and exploring of content by learners, and wherein the second layer tracks activities of the course authors.

6. The adaptive education system of claim 5, wherein the social network engine is further to:
use the network of knowledge and the social learning network to identify recommended CHUNKs for a new learner;
maintain content communities for the course authors; and
maintain social communities for the learners.

7. The adaptive education system of claim 4, further comprising a selector to receive a selection of display options for the presentation engine from one of the learners;
wherein the presentation engine is further to display the network of knowledge according to a preferred View of the learner, wherein the preferred view is saved in a learner profile of the learner.

8. The adaptive education system of claim 7, further comprising a recommender engine to identify relevant CHUNKs based on a learner profile of the learner;
wherein the presentation engine is further to display at least a portion of the relevant CHUNKs for selection by the learner.

9. The adaptive education system of claim 8, wherein the learner profile comprises metadata describing the learner.

10. The adaptive education system of claim 8, further comprising a learner feedback engine to:
collect quality assessments of the aggregated learning content from the learners; and
receive learner preferences from the learner to improve delivery of personalized content for the learner.

11. The adaptive education system of claim 8, further comprising an analytics engine to, in response to receiving a request from a user, query the aggregated learning content data for educational content matching the request and most similar to the learner profile.

12. The adaptive education system of claim 11, wherein the presentation engine is further to display the education content for the learner.

13. The adaptive education system of claim 8, wherein the analytics engine is further to, in response to receiving a request from the learner. determine that suitable content is not available and communicates with the aggregation engine to use artificial intelligence to create new aggregated learning content based on historical learning activities of the learners.

14. The adaptive education system of claim 11, wherein the aggregation engine is further to:
use dynamic learner profile data from the analytics engine to query learning activities records of the learner;
organize the aggregated learning content into collections; and
provide a relevant subset of the collections to the recommender engine for display by the presentation engine.

15. The adaptive education system of claim 1, wherein a CHUNKlet of the assessment type is used to assess competency of a learner in a target skill, and wherein the adaptive education system further comprises a performance feedback engine to add the target skill to a learner profile of the learner if the CHUNKlet of the assessment type is passed.

16. An adaptive education system, comprising
a storage device to store aggregated learning content that comprises:
learning units comprising learning material, the learning material comprising at least one from a group consisting of audio material, visual material, audiovisual material, and interactive material,
CHUNKlets, each CHUNKlet being of a CHUNKlet type and comprising a plurality of learning units, wherein the CHUNKlet type is one from a group consisting of an introductory type, an assessment type, an application type, and a methodology type, and
CHUNKs, each CHUNK comprising a plurality of CHUNKlets; a mapping engine to:
tag each of the CHUNKlets with learning outcomes and descriptive keywords;
map, in a network of knowledge, the prerequisite relationships through directed edges that connect each CHUNK with required CHUNKs of the CHUNK; and
map, in the network of knowledge, disciplinary relationships through bidirectional edges between CHUNKs, each disciplinary relationship capturing an aggregation of CHUNKlets that represent a unit or a topic of knowledge.

17. The adaptive education system of claim 16, further comprising a presentation engine to display a portion of the network of knowledge that represents the directional edges between CHUNKs and the bidirectional edges between the CHUNKs and the units and the topics of knowledge.

18. The adaptive education system of claim 16, further comprising a social network engine to:
create a social learning network with two layers, wherein the first layer tracks learning and exploring of content by learners, and wherein the second layer tracks activities of the course authors.

19. An adaptive education system, comprising
a storage device to store aggregated learning content that comprises:
learning units comprising learning material, the learning material comprising at least one from a group consisting of audio material, visual material, audiovisual material, and interactive material,
CHUNKlets, each CHUNKlet being of a CHUNKlet type and comprising a plurality of learning units, wherein the CHUNKlet type is one from a group consisting of an introductory type, an assessment type, an application type, and a methodology type, and
CHUNKs, each CHUNK comprising a plurality of CHUNKlets; a learner feedback engine to create a learner profile for a learner by:
collecting quality assessments of the aggregated learning content from a learner; and
receiving learner, preferences from the learner to improve delivery of personalized content for the learner; and
a recommender engine to identify relevant CHUNKs based on the lean er profile of the learner.

20. The adaptive education system of claim 19, further comprising an analytics engine to, in response to receiving a request from the learner, query the aggregated learning content data for educational content matching the request and most similar to the learner profile.
